(19) United States
(12) Patent Application Publication
(10) Pub. No.: US 2015/0026379 A1
(43) Pub. Date: Jan. 22, 2015

(54) GENERIC METHOD TO BUILD VIRTUAL PCI DEVICE AND VIRTUAL MMIO DEVICE

(71) Applicants: Wei Yang, Shanghai (CN); Chao Xu, Shanghai (CN); Li Liang, Shanghai (CN)

(72) Inventors: Wei Yang, Shanghai (CN); Chao Xu, Shanghai (CN); Li Liang, Shanghai (CN)

(21) Appl. No.: 14/126,865

(22) PCT Filed: Mar. 14, 2013
(86) PCT No.: PCT/CN2013/072583

§ 371 Date: Dec. 17, 2013

(51) Int. Cl. G06F 13/40; G06F 13/42

(52) U.S. Cl. CPC G06F 13/4068; G06F 13/42
USPC 710/305

(57) ABSTRACT

A technology for implementing a method to build a virtual device as at least one of a virtual Peripheral Controller Interconnect (PCI) device or a virtual Input/Output (I/O) device is disclosed. A method of the disclosure includes receiving a request for a PCI compatible device. The method further includes building a virtual device based on the request for the PCI compatible device, where the virtual device is built as at least one of a virtual PCI device or a virtual I/O device.

### TECHNICAL FIELD

Embodiments described herein generally relate to processing devices and, more specifically, relate to a generic method to build a virtual PCI device and a virtual MMIO device.

### BACKGROUND

A computing system can include multiple components, such as a processing device (e.g., microcontroller, microprocessor, etc.), memory blocks, timing sources, peripheral devices, external interfaces, analog interfaces, voltage regulators, power management circuits, etc. The memory blocks, external interfaces, or other components can include functional blocks, also known as IP blocks or controllers, which provide an interface between the processing device and a peripheral device.

The components in the computing system can communicate with software accessible to the computing system and with peripheral devices in different ways, such as through a Peripheral Component Interconnect (PCI) bus. Software can be booted from some peripheral devices, such as a flash memory, and then executed by the processing device in the computing system.

However, some components in the computing system, such as functional blocks, may not be PCI compatible and thus may not be able to communicate with software that uses the PCI bus for communication. Moreover, some software cannot be booted from certain peripheral devices, such as PCI compatible peripheral devices.

Multiple solutions have been utilized to address these issues. Current approaches to address the inability of a functional block to communicate with software that uses a PCI bus for communication include a hardware approach and a software approach. The current hardware approach requires changing the hardware design of the functional block in order to make the functional block PCI compatible. The current software approach requires creating software for the functional block, such as a specific device driver for the functional block which can work around the incompatibility of the functional block. A current approach to address the inability of software to boot from a PCI compatible peripheral device requires changing the hardware construction of the PCI compatible peripheral device (e.g., changing the silicon). However, these approaches may take a considerable amount of time and cost.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram of one embodiment of a processing device that implements a generic method to build a virtual device as a virtual PCI device or a virtual I/O device;

FIG. 2 is a block diagram illustrating a virtual device module to implement the generic method to build a virtual device as a virtual PCI device or a virtual device according to an embodiment of the disclosure;

FIG. 3 is a flow diagram illustrating a method for building a virtual device as a PCI device or a virtual I/O device according to an embodiment of the disclosure;

FIG. 4 is a flow diagram illustrating a method for building a virtual device as a virtual PCI device according to an embodiment of the disclosure;

FIG. 5 is a flow diagram illustrating a method for building a virtual device as a virtual I/O device according to an embodiment of the disclosure;

FIG. 6 is a flow diagram illustrating a method for using a virtual device according to an embodiment of the disclosure;

FIG. 7 is a block diagram of a computer system according to an embodiment of the disclosure;

FIG. 8 is a block diagram of a computing system according to another embodiment of the disclosure; and

FIG. 9 is a block diagram of a computing system according to another embodiment of the disclosure.

### DETAILED DESCRIPTION

Software, such as an operating system or an application running on an operating system of a computing system, may access a hardware device (e.g., peripheral device) in the computing system using a driver. When the driver requests access to the hardware device, the driver may send the access request via a functional block associated with the hardware device. The functional block can then access the hardware device, receive a response from the hardware device, and transmit a response to the driver. Therefore, the functional block serves as an interface between the driver (and corresponding software) and the hardware device. The functional block may be transparent to the driver and/or the hardware device. The driver may request access to the hardware device by writing commands for the hardware device (e.g., access commands such as read or write) to a Peripheral Component Interconnect (PCI) bus in the computing system. However, if the functional block corresponding to the hardware device is not PCI compatible, the functional block may not be aware that the driver is trying to access the hardware device or may not be able to communicate with the driver.

Moreover, an operating system, may only be able to boot from some hardware devices, such as input/output (I/O) devices, and may not be able to boot from other hardware devices. For example, an operating system may not be able to hoot from a peripheral device that the operating system considers a removable device, such as a PCI compatible device. However, the computing system may not consider the hardware device as removable, and may want the operating system to boot from the hardware device.

Embodiments of the disclosure provide for a generic method to build a virtual device as either a virtual PCI device or a virtual I/O device. In one embodiment, a method of the disclosure includes receiving a request for a PCI compatible device. The method further includes building a virtual device based on the request for the PCI compatible device, where the virtual device is built as at least one of a virtual PCI device or a virtual I/O device.

The virtual device can be built as a virtual PCI device for a functional block that is not PCI compatible and the virtual device can be built as a virtual I/O device for a PCI compatible device that is associated with an operating system to be booted from the PCI compatible device. By building the virtual device as a virtual PCI device for a functional block that is not PCI compatible, any accesses and/or requests sent by software on the PCI bus for the PCI compatible device associated with the functional block can be recognized by the virtual device and can be transmitted to the functional block. Therefore, the virtual device provides an interface for the functional block that is not PCI compatible to receive PCI compatible accesses and/or requests. By building the virtual device as a virtual I/O device for a PCI compatible device that is associated with an operating system to be booted from the PCI compatible device, the operating system can boot from the virtual device because the operating system will determine that the device from which it is booting from is an I/O device rather than a PCI compatible device.

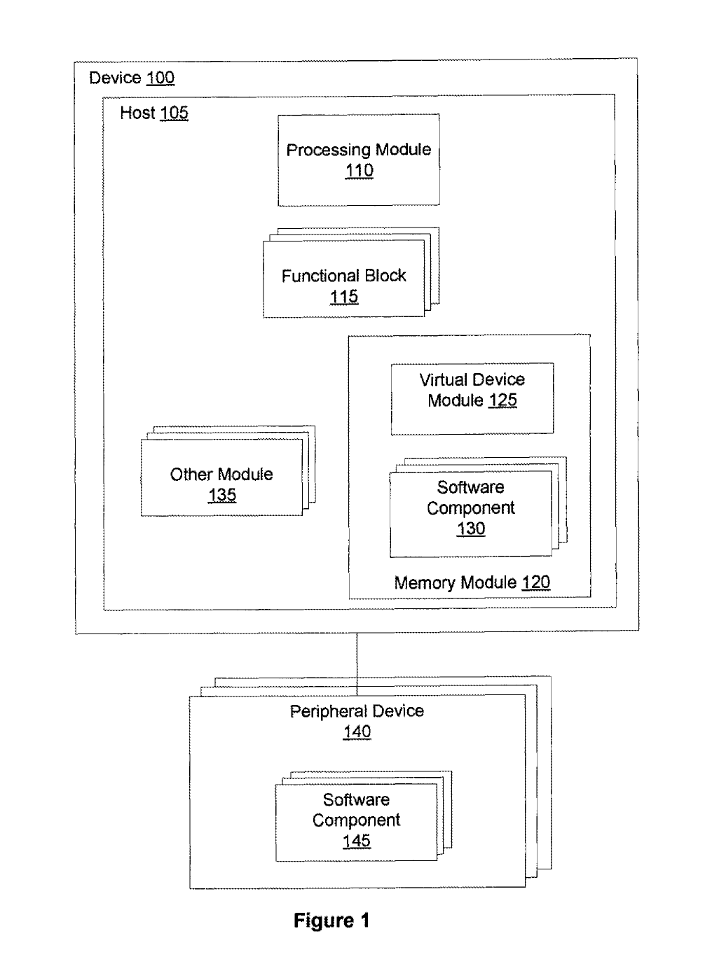

FIG. 1 is a block diagram of a device 100 that implements a generic method to build a virtual PCI device and a virtual MMIO device according to an embodiment of the disclosure. Some examples of device 100 may include, but are not limited to, a mobile communications device such as a cellular handset or smart phone, a mobile computing device such as a tablet computer, a netbook, a notebook computer, a laptop computer, a desktop computer, a server computer, and so on.

Device 100 may include, for example, host 105 to handle baseline operations for device 100. Host 105 may include, for example, a processing module 110, functional blocks 115, memory module 120, and other modules 135. Processing module 110 may comprise one or more processors (also known as processing devices) situated in separate component, or alternatively, one or more processing cores embodied in a single integrated circuit (IC) arranged, for example, in a System-on a-Chip (SOC) configuration.

Functional blocks 115 may include circuitry configured to support processing module 110. The functional blocks 115 can include interface/bridging circuitry. In one embodiment, each functional block 115 is an integrated circuit (IC) configured to handle communications associated with a specific bus (e.g., PCI, Serial AT Attachment (SATA), Universal Serial Bus (USB), etc.) or an interface (e.g., multimedia card (MMC) devices, embedded multimedia card (eMMC) devices, secure digital (SD) devices, etc.) in device 100. For example, if device 100 includes a bus and/or interface for PCI, SATA, USB, MMC, eMMC, and SD devices, then the device 100 will include a functional block 115 (e.g., controller) that is a PCI controller, a functional block 115 that is a SATA controller, a functional block 115 that is a USB controller, functional block 115 that is an MMC controller, a functional block 115 that is an eMMC controller, and a functional block 115 that is an SD controller. A functional block 115 may handle signaling between various modules by converting from one type/speed of communication to another. Each functional block 115 may also be compatible with a variety of different devices to allow for different system implementations, upgrades, etc. Some of the functionality of the functional blocks 115 may also be incorporated into processing module 110, memory module 120, or other modules 135.

Processing module 110 may execute instructions. Instructions may include program code to cause processing module 110 to perform activities such as, but not limited to, reading data, writing data, processing data, formulating data, converting data, transforming data, etc. Information, including instructions, data, etc. (not shown) may be stored in memory module 120.

Memory module 120 may include random access memory (RAM) or read-only memory (ROM) in a fixed or removable format. RAM may include memory to hold information during the operation of the device 100 such as, for example, static RAM (SRAM) or dynamic RAM (DRAM). ROM may include memories such as computing device BIOS memory to provide instructions when device 100 activates, programmable memories such as electronic programmable ROMs (EPROMs), Flash, etc. Other fixed and/or removable memory may include magnetic memories such as floppy disks, hard drives, etc., electronic memories such as solid state Flash memory (e.g., eMMC, etc.), removable memory cards or sticks (E.g., USB, micro-SD, etc.), optical memories such as compact disc-based ROM (CD-ROM), holographic, etc.

Other modules 135 may include modules directed to supporting other functionality within device 100. Other modules 135 may include, for example, modules to supply power to device 100, modules to support wired and/or wireless communications in device 100, modules to provider user interface (UI) features in device 100, modules to support specialized functionality, etc. The composition of other modules 100 may be variable depending upon, for example, form factor, the use for which device 100 has been configured, etc.

Peripheral devices 140 may include removable or non-removable peripheral devices, such as PCI compatible peripheral devices, Memory-Mapped I/O (MMIO) peripheral devices, magnetic memories such as floppy disks, hard drives, etc., electronic memories such as solid state Flash memory (e.g., eMMC, etc.), removable memory cards or sticks (e.g., USB, micro-SD, etc.), optical memories such as compact disc-based ROM (CD-ROM), holographic memories, etc. A peripheral device can be identified by a bus number to which it is attached and by a device number for the type of the peripheral device. A peripheral device 140 may include one or more software components 145 (e.g., application, operating system, etc.) stored on the peripheral device 140.

An embodiment of memory module 120 may include a virtual device module 125 and one or more software components 130. The software components 130 can include applications, an operating system, a BIOS, an System Management Interrupt (SMI) handler, etc. In one embodiment, a software component 130 sends a request (e.g., enumeration request, access request, etc.) for a peripheral device 140 to the virtual device module 125. The request can be a request to obtain information for the peripheral device 140, such as a vendor identifier, a device identifier, and address information for the peripheral device 140. If the information is returned by the virtual device module 125, the software component 130 can use the information to communicate with the peripheral device 140 via PCI.

The virtual device module 125 can receive the request for the peripheral device 140. The virtual device module 125 can build a virtual device based on the request for the peripheral device 140. The virtual device can be a virtual PCI device or a virtual MMIO device.

The virtual device module 125 can build a virtual device that is a virtual PCI device if the virtual device module 125 determines that the peripheral device 140 in the request is associated with a functional block 115 that is not PCI compatible. A functional block 115 is not PCI compatible if the functional block 115 cannot read or write access requests to a PCI bus. In one embodiment, the virtual device module 125 determines whether the functional block 115 is not PCI compatible by reading or writing an access request to the functional block 115. If the functional block 115 returns an error or other indication that the functional block 115 cannot read or write the access request, the virtual device module 125 can determine that the functional block 115 is not PCI compatible. In an alternate embodiment, the virtual device module 125 determines whether the functional block 115 is not PCI compatible by obtaining compatibility information from the functional block 115 and determining whether the compatibility information for the functional block 115 includes PCI. In another embodiment, the virtual device module 125 determines whether the functional block 115 is not PCI compatible by obtaining compatibility information from the hardware specification for the device 100. In yet another embodiment, the virtual device module 125 determines whether the functional block 115 is not PCI compatible by obtaining compatibility information from an SMI handler (not shown), a BIOS (not shown), etc. If the compatibility information for the functional block 115 does not include PCI, then the functional block 115 is not PCI compatible. In one embodiment, the virtual device module 125 builds the virtual device as a virtual PCI device by determining information (e.g., a vendor identifier, a device identifier, and address information) for the virtual PCI device. In some embodiments, the virtual device module 125 sends the information to the software component 130 in response to the request from the software component 130.

The virtual device module 125 can build a virtual device that is a virtual MMIO device if the virtual device module 125 determines that the peripheral device 140 in the request is associated with a software component 145 to be booted from the peripheral device 140. In one embodiment, the virtual device module 125 determines whether the peripheral device 140 is associated with a software component 145 to be booted from the peripheral device by accessing the one or more software components 145 stored on the peripheral device 140 and determining whether any of the software components are predefined software components (e.g., operating system, etc.). In one embodiment, the virtual device module 125 builds the virtual device as a virtual I/O device by discarding the request received from the software component 130 and determining an I/O address range for the virtual I/O device.

Once the virtual device is built for a peripheral device 140, the virtual device module 125 can store the virtual device in a memory, such as memory module 120. In some embodiments, if the virtual device is a virtual PCI device for the peripheral device 140, the virtual device module 125 provides one or more of the software components 130 (e.g., the software component 130 that sent the request for the peripheral device 140) with a vendor identifier, a device identifier, and address information for the created virtual device. In some embodiments, if the virtual device is a virtual I/O device for the peripheral device 140, the software components 130 no longer directly access the peripheral device 140 for which the request was sent, but instead access the virtual PCI device or the virtual I/O device for the peripheral device 140. The virtual device module 125 can further provide an interface between the software components 130 and the virtual device. In some embodiments, upon receiving an access to an I/O address from a software component 130, the virtual device module 125 determines if the I/O address is within a range of a virtual device that is a virtual I/O device. In these embodiments, if the virtual device module 125 determines that the I/O address is within a range of a virtual device that is a virtual I/O device, the virtual device module 125 translates the I/O address to a PCI address prior to providing the access request to a peripheral device 140 associated with the virtual I/O device.

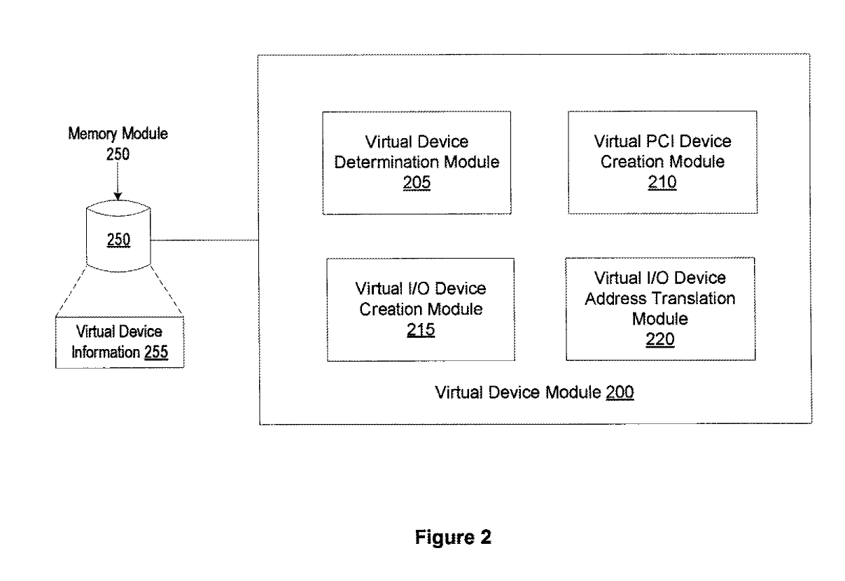

FIG. 2 illustrates a virtual device module 200 to implement a generic method to build a virtual PCI device and a virtual MMIO device, in accordance with one embodiment of the present disclosure. In one embodiment, the virtual device module 200 is the same as the virtual device module 125 described above with respect to FIG. 1. The virtual device module 200 may include a virtual device determination module 205, a virtual PCI device creation module 210, a virtual I/O device creation module 215, and a virtual I/O device address translation module 220. More or less components may be included in the virtual device module 200 without loss of generality.

The virtual device determination module 205 can receive a request for a peripheral device. The request can include identification information about the request, such as whether the request is an access request, an enumeration request, etc. The request can further include identification information for the peripheral device, such an address for the peripheral device. The virtual device module 125 can determine whether to build the virtual device as a virtual PCI device or a virtual I/O device based on the request for the peripheral device.

The virtual device determination module 205 can determine that the virtual device should be built as a virtual PCI device if the peripheral device in the request is associated with a functional block that is not PCI compatible. In one embodiment, the virtual device determination module 205 determines whether the peripheral device in the request is associated with a functional block that is not PCI compatible by obtaining compatibility information from the functional block and determining whether the compatibility information for the functional block includes PCI. In this embodiment, if the compatibility information for the functional block does not include PCI, then the virtual device determination module 205 determines that the functional block is not PCI compatible. In this embodiment, if the compatibility information for the functional block does include PCI, then the virtual device determination module 205 determines that the functional block is PCI compatible. In an alternate embodiment, the virtual device determination module 205 determines whether the peripheral device in the request is associated with a functional block that is not PCI compatible by obtaining the information from an SMI handler (not shown), trap handler (not shown), or interrupt handler (not shown). If the peripheral device is associated with a functional block that is not PCI compatible, the virtual device determination module 205 can send a request to the virtual PCI device creation module 210 to build a virtual PCI device as the virtual device.

The virtual device determination module 205 can determine that the virtual device should be built as a virtual I/O device if the peripheral device in the request is associated with software (e.g., operating system) to be booted from the peripheral device. In one embodiment, the virtual device determination module 205 determines whether the peripheral device is associated with software to be booted from the peripheral device by accessing the software stored on the peripheral device and determining whether any of the software is a predefined type of software (e.g., operating system, etc.). In an alternate embodiment, the virtual device determination module 205 determines whether the peripheral device is associated with software to be booted from the peripheral device by obtaining the information from an SMI handler, trap handler, or interrupt handler. If the peripheral device in the request is associated with software to be booted from the peripheral device, the virtual device determination module 205 can send a request to the virtual I/O device creation module 215 to create a virtual I/O device as the virtual device.

The virtual PCI device creation module 210 can receive a request from the virtual device determination module 205 to create a virtual PCI device. The virtual PCI device creation module 210 can create the virtual PCI device by determining identification information and address information for the virtual PCI device based on the functional block associated with the peripheral device. The identification information can include a vendor identifier, a device identifier, etc. The address information can include an address range that can be used by a software (not shown) to access the virtual PCI device. In one embodiment, the virtual PCI device creation module 210 obtains the identification information and the address information from an WI handler, a trap handler, or an interrupt handler. Once the virtual PCI device creation module 210 creates a virtual PCI device, the virtual PCI device creation module 210 can store the virtual PCI device in memory. In one embodiment, the virtual PCI device creation module 210 stores the virtual PCI device as a virtual device in virtual device information 255 in memory module 250.

The virtual I/O device creation module 215 can receive a request from the virtual device determination module 205 to create a virtual I/O device. The virtual I/O device creation module 215 can create the virtual I/O device by discarding the request for the peripheral device and determining an I/O address range for the virtual I/O device. In one embodiment, the virtual I/O device creation module 215 discards the request for the peripheral device by not responding to the request for the peripheral device. In an alternate embodiment, the virtual I/O device creation module 215 discards the request for the peripheral device by transmitting a response to the request that the request failed (e.g., unsuccessful PCI read). Once the virtual I/O device creation module 215 creates a virtual I/O device, the virtual I/O device creation module 215 can store the virtual I/O device in memory. In one embodiment, the virtual I/O device creation module 215 stores the virtual I/O device in virtual device information 255 in memory module 250.

The virtual I/O device address translation module 220 can receive a request or an access to an I/O address. In one embodiment, the request or the access is received from software. In response to the request or access, the virtual I/O device address translation module 220 may determine if the I/O address is within the address range of a virtual device that is a virtual I/O device. The virtual I/O device address translation module 220 can determine if the I/O address is within the address range of a virtual I/O device by comparing the I/O address with the address range for each virtual device that is a virtual I/O device. In one embodiment, the virtual I/O device address translation module 220 compares the I/O address to the address ranges in virtual device information 255. If the virtual I/O device address translation module 220 determines that the I/O address is within an address range of a virtual device that is a virtual I/O device, the virtual I/O device address translation module 220 may translate the I/O address to a PCI address and can cause the PCI address of the peripheral device associated with the virtual device to be accessed.

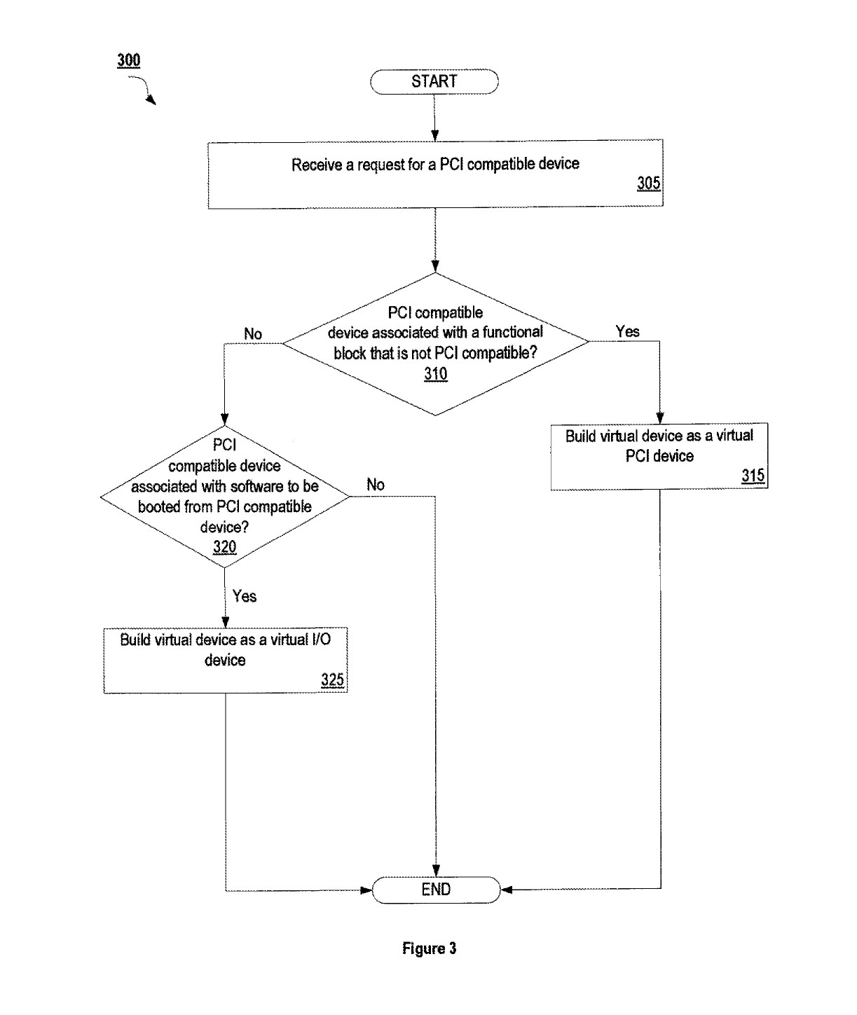

FIG. 3 is a flow diagram of a method 300 for building a virtual PCI device and a virtual MMIO device according to an embodiment of the disclosure. Method 300 may be performed by processing logic that may comprise hardware (e.g., circuitry, dedicated logic, programmable logic, microcode, etc.), software (such as instructions run on a processing device), firmware, or a combination thereof. In one embodiment, method 300 is performed by device 100 described with respect to FIG. 1.

At block 305, processing logic receives a request for a PCI compatible device. The PCI compatible device can be a peripheral device that can be attached to a PCI bus. The request for the PCI compatible device can include identification information about the request, such as whether the request is an access request, an enumeration request, etc. In one embodiment, the request is an enumeration request received from an SMI handler while a processing device is performing the method 300 is in System Management Mode (SMM).

SMM is a mode of operation where all normal execution (including the OS) of the processing device is suspended, and special separate software (usually firmware or a hardware-assisted debugger) is executed in a high-privilege mode. SMM provides an isolated memory and execution environment, and SMM code is invisible to the operating system (OS) while retaining full access to memory and complete control over peripheral devices, such as PCI compatible devices, etc. When SMM is initiated, the current state of the processing device is saved and all other processes are stopped. High privileged operations may be performed in SMM mode, such as debugging, hardware management, security functions, emulation, etc., followed by the processing device resuming operation based on the save state of the processing device. Upon occurrence of an System Management Interrupt (SMI), the processing device may enter the SMM and run an SMI handler. An SMI can be generated when execution of the processing device is started (booting), when a new peripheral device is added to the device, etc. For example, firmware or the BIOS can generate an SMI upon booting.

Upon receiving an SMI, the SMI handler can enumerate the PCI compatible (peripheral) devices available to the processing device by querying (e.g., attempting to read) a PCI bus to determine the PCI compatible device(s). If the SMI is generated response to booting, all of the PCI compatible devices in the device may not have been enumerated. If the SMI is generated in response to a new PCI compatible device being added, the new PCI compatible device may not have been enumerated. The SMI handler can generate an enumeration request for each PCI compatible device that has not yet been enumerated. The enumeration request may include identification information for the PCI compatible device, such as a bus number and device number for the PCI compatible device.

Returning to FIG. 3, at block 310, processing logic determines if the PCI compatible device in the request is associated with a functional block that is not PCI compatible. A functional block is not PCI compatible if the functional block cannot read or write access requests to a PCI bus.

In one embodiment, processing logic determines whether the peripheral device in the request is associated with a functional block that is not PCI compatible by obtaining compatibility information from a functional block associated with the PCI compatible device and determining whether the compatibility information for the functional block includes PCI compatibility. If the compatibility information for the functional block includes PCI compatibility, processing logic determines that the PCI compatible device is not associated with a functional block that is not PCI compatible (in other words, the PCI compatible device is associated with a functional block that is PCI compatible). If the compatibility information for the functional block does not include PCI compatibility, processing logic determines that the PCI compatible device is associated with a functional block that is not PCI compatible.

In an alternate embodiment, processing logic determines whether the peripheral device in the request is associated with a functional block that is not PCI compatible by obtaining compatibility information for the functional block associated with the PCI compatible device from an SMI handler. The compatibility information can include whether or not the functional block associated with the PCI compatible device is PCI compatible. The SMI handler can collect information about drivers and/or software (e.g., applications) running or to be run on the processing device, and can determine which PCI compatible devices are supported by the drivers and/or software. The SMI handler can collect the information about the drivers and/or software from documentation, from the driver or software source code, etc. Upon determining the PCI compatible devices supported by the drivers and/or software, the SMI handler can determine the corresponding functional block (e.g., controller) for each of the PCI compatible devices and determine if the corresponding functional block is PCI compatible. The SMI handler can access each of the functional blocks to determine the PCI compatibility of each of the functional blocks. For example, device type information for each of the functional blocks can be accessible to the SMI handler. In one embodiment, processing logic can obtain the compatibility information for the functional block associated with the PCI compatible device from the SMI handler by sending a request for the compatibility information for a functional block and receiving the compatibility information for the functional block from the SMI handler. In an alternate embodiment, processing logic can obtain the compatibility information for the functional block from the SMI handler by accessing a predefined memory location written to by the SMI handler. If the compatibility information includes compatibility information that the functional block is not PCI compatible, processing logic determines that the PCI compatible device is associated with a functional block that is not PCI compatible. If the compatibility information for the functional block includes information that the functional block is PCI compatible, processing logic determines that the PCI compatible device is not associated with a functional block that is not PCI compatible (in other words, the PCI compatible device is associated with a functional block that is PCI compatible).

In another alternate embodiment, processing logic determines whether the peripheral device in the request is not PCI compatible by reading or writing an access request to the peripheral device in the request. If the peripheral device in the request returns an error or other indication that the peripheral device in the request cannot read or write the access request, processing logic can determine that the peripheral device in the request is not PCI compatible.

If processing logic determines that the PCI compatible device is not associated with a functional block that is not PCI compatible, the method 300 proceeds to block 320. If processing logic determines that the PCI compatible device is associated with a functional block that is not PCI compatible, the method 300 proceeds to block 315.

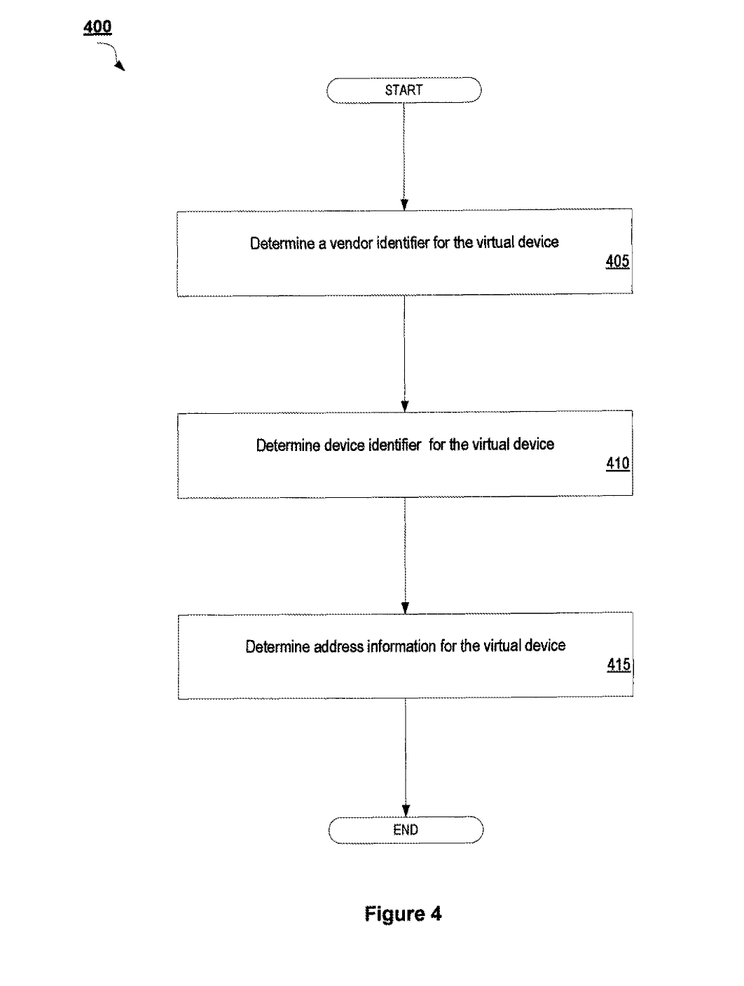

At block 315, processing logic builds a virtual device as a virtual PCI device. Processing logic can build the virtual device as a virtual PCI device by determining PCI identification information and address information for the virtual device. One implementation of building a virtual device as a virtual PCI device is described below with reference to FIG. 4. In one embodiment, upon building the virtual device, processing logic can optionally provide a response to the request received at block 305. The response to the request can include a successful read of predetermined registers associated with the virtual device, and can further include identifier information for the virtual device, such as a vendor identifier, a device identifier, an I/O address range, and an MMIO address range for the virtual device. For example, an enumeration request for General Purpose Input/Output (GPIO) device with a GPIO controller that is not PCI compatible will receive a successful response and include a vendor identifier (e.g., 0x8888), a device identifier (e.g., 0x9999), an I/O address range (e.g., 0x200-0x20F), and an MMIO range (0xA0000-0xA00FF) for a virtual device created for the GPIO controller associated with the GPIO device.

At block 320, processing logic determines whether the PCI compatible device is associated with software to be booted from the PCI compatible device. The software to be booted from the PCI compatible device can be an operating system, a software application, a BIOS, etc. In some embodiments, the software to be booted from the PCI compatible device is software that requires booting from an I/O device, such a Memory-Mapped I/O peripheral device. In these embodiments, the software may be designed not to boot from peripheral devices that are considered removable devices, such as PCI compatible devices (e.g., embedded Multimedia Memory Card (eMMC), etc.). However, some PCI compatible devices are not removable, such as PCI devices in an SOC.

In one embodiment, processing logic determines whether the PCI compatible device is associated with software to be booted from the PCI compatible device by accessing the software components stored on the PCI compatible device and determining whether the software components is a predefined software component. Processing logic can determine whether the software component is a predefined software component by comparing the software component to one or more predefined software components that have been determined to be on a peripheral device that is not removable (e.g., an operating system on an eMMC, etc.). If the comparison indicates that the software components stored on the PCI compatible device include one or more of the predetermined software component s, processing logic can determine that the PCI compatible device is associated with software to be booted from the PCI compatible device. If the comparison indicates that the software component s stored on the PCI compatible device do not include one or more of the predetermined software components, processing logic can determine that the PCI compatible device is not associated with software to be booted from the PCI compatible device.

In an alternate embodiment, processing logic determines whether the PCI compatible device is associated with software to be booted from the PCI compatible device by obtaining software information from an SMI handler. In one such embodiment, the software information obtained from the SMI handler includes the software components on the PCI compatible device. In this embodiment, the SMI handler can collect information about drivers and/or software components stored on the PCI compatible device. In this embodiment, processing logic can obtain the software information and compare the software information to one or more predetermined software components that have been determined to be on a peripheral device that is not removable (e.g., an operating system on an eMMC, etc.). If the comparison indicates that the software information includes one or more of the predetermined software components, processing logic can determine that the PCI compatible device is associated with software to be booted from the PCI compatible device. If the comparison indicates that the software information does not include one or more of the predetermined software components, processing logic can determine that the PCI compatible device is not associated with an software to be booted from the PCI compatible device. In an alternate such embodiment, the software information includes an indicator (e.g., positive indicator, such as a bit set to 1, or negative indicator, such as a bit set to 0) of whether any of the software components on the PCI compatible device are to be booted from the PCI compatible device. In this embodiment, processing logic obtains the software information and determines that the PCI compatible device is associated with software to be booted from the PCI compatible device based on the indicator. If the indicator indicates that software on the PCI compatible device is to be booted from the PCI compatible device (e.g., positive indicator), then processing logic can determine that the PCI compatible device is associated with software to be booted from the PCI compatible device. If the indicator indicates that the PCI compatible device is not associated with software to be booted from the PCI compatible device (e.g., negative indicator), then processing logic can determine that the PCI compatible device is not associated with software to be booted from the PCI compatible device.

In one embodiment, processing logic can obtain the software information for the PCI compatible device from the SMI handler by sending a request for the software information for the PCI compatible device and receiving the software information for the PCI compatible device from the SMI handler. In an alternate embodiment, processing logic can obtain the software information for the PCI compatible device from the SMI handler by accessing a predefined memory location written to by the SMI handler.

If processing logic determines that the PCI compatible device is not associated with software to be booted from the PCI compatible device, the method 300 ends with no virtual device being built. If processing logic determines that the PCI compatible device is associated with software to be booted from the PCI compatible device, the method 300 proceeds to block 325.

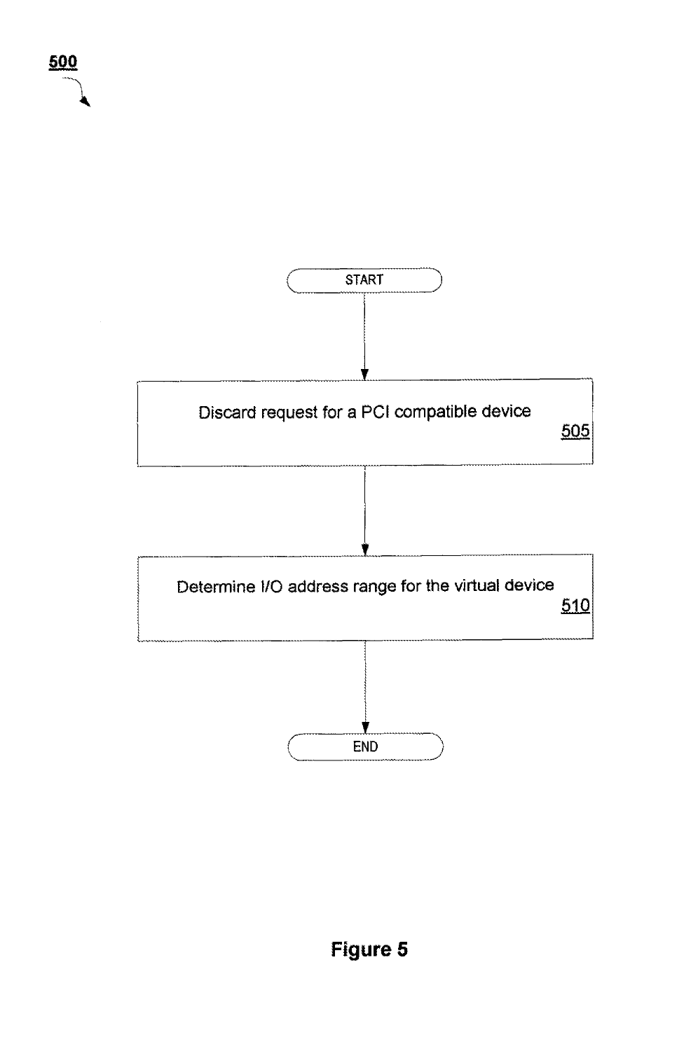

At block 325, processing logic builds a virtual device as a virtual I/O device. In one embodiment, the virtual I/O device is a virtual MMIO device. One implementation of building a virtual device as a virtual I/O device is described below with reference to FIG. 5. In one embodiment, upon building the virtual device, processing logic can optionally provide a response to the request received at block 305. The response to the request can include an unsuccessful read of predetermined registers associated with the PCI compatible device.

FIG. 4 is a flow diagram of a method 400 for building a virtual device as a virtual PCI device according to an embodiment of the disclosure. Method 400 may be performed by processing logic that may comprise hardware (e.g., circuitry, dedicated logic, programmable logic, microcode, etc.), software (such as instructions run on a processing device), firmware, or a combination thereof. In one embodiment, method 400 is performed by device 100 described with respect to FIG. 1.

At block 405, processing logic determines a vendor identifier for the virtual device. In one embodiment, the vendor identifier is determined by obtaining the vendor identifier from an SMI handler or BIOS. The vendor identified from the SMI handler or BIOS can be assigned by the SMI handler or the BIOS, or can be match a vendor identifier required by a driver or a software component. For example, if a driver is asking for a vendor identifier “0x8086”, the SMI handler or BIOS will assign vendor identifier “0x8086” to the virtual device. In an alternate embodiment, the vendor identifier is determined by determining a vendor identifier associated with the PCI compatible device and configuring the vendor identifier for the virtual device to be the same as the determined vendor identifier. For example, if the PCI compatible device is a GPIO device with a vendor identifier of 0x8888, then the corresponding vendor identifier for the virtual device will also be 0x8888.

At block 410, processing logic determines a device identifier for the virtual device. In one embodiment, the device identifier is determined by obtaining the device identifier from an SMI handler or BIOS. The vendor identified from the SMI handler or BIOS can be assigned by the SMI handler or the BIOS, or can be match a vendor identifier required by a driver or a software component. For example, if a driver is asking for a device identifier “0x8086”, the SMI handler or BIOS will assign device identifier “0x8086” to the virtual device. In an alternate embodiment, the device identifier is determined by determining a device identifier associated with the PCI compatible device and configuring the device identifier for the virtual device to be the same as the determined device identifier. For example, if the PCI compatible device is a GPIO device with a device identifier of 0x9999, then the corresponding device identifier for the virtual device will also be 0x9999.

At block 415, processing logic determines address information for the virtual device. The address information for the virtual device can be an address 110 address range and an MMIO address range for the virtual device. In one embodiment, the address information is determined by obtaining the address information from an SMI handler, BIOS, or hardware specification. In an alternate embodiment, the address information is determined by determining address information associated with the PCI compatible device and configuring the address information for the virtual PCI device to be the same as the determined address information. For example, if the PCI compatible device is a GPIO device with address information including an I/O range of 0x200 to 0x20F and an MMIO address range of 0xA0000 to 0xA00FF, then the corresponding address information for the virtual device will also be an I/O range of 0x200 to 0x20F and an MMIO address range of 0xA0000 to 0xA00FF. The address information can include an address range for the virtual device that can be used by a software component (not shown) to access the virtual device.

FIG. 5 is a flow diagram of a method 500 for building a virtual device as a virtual I/O device according to an embodiment of the disclosure. Method 500 may be performed by processing logic that may comprise hardware (e.g., circuitry, dedicated logic, programmable logic, microcode, etc.), software (such as instructions run on a processing device), firmware, or a combination thereof. In one embodiment, method 500 is performed by device 100 described with respect to FIG. 1.

At block 505, processing logic discards a request for a PCI compatible device. In one embodiment, the request is an enumeration request associated with the PCI compatible device. By discarding the request for the PCI compatible device, processing logic can provide feedback to software that made the request that there is no PCI compatible device associated with the request. This will cause the software to believe that the software is stored on an MMIO device or that the software is accessing an MMIO device. In one embodiment, processing logic discards the request for the PCI compatible device by not responding to the request. In an alternate embodiment, processing logic discards the request for the PCI compatible device by generating a response to the request that includes an unsuccessful read of one or more predetermined registers associated with the PCI compatible request (e.g., PCI configuration registers associated with a vendor identifier and device identifier provided in the request).

At block 510, processing logic determines an I/O address range for the virtual I/O device. In one embodiment, the I/O address range is an MMIO address range. In one embodiment, processing logic determines the I/O address range for the virtual I/O device by obtaining the I/O address range from an SMI handler. In an alternate embodiment, processing logic determines the I/O address range for the virtual I/O device by obtaining (e.g., parsing) the I/O address range for the PCI compatible device from an Advanced Configuration and Power Interface (ACPI) table. An ACPI specification can provide an open standard for device configuration and power management by the operating system. The ACPI table can include device resource information for devices available in the system. The device resource information for a device can include a device name, an MMIO address range, an I/O address range, an interrupt mechanism, a device associated with the device, etc.

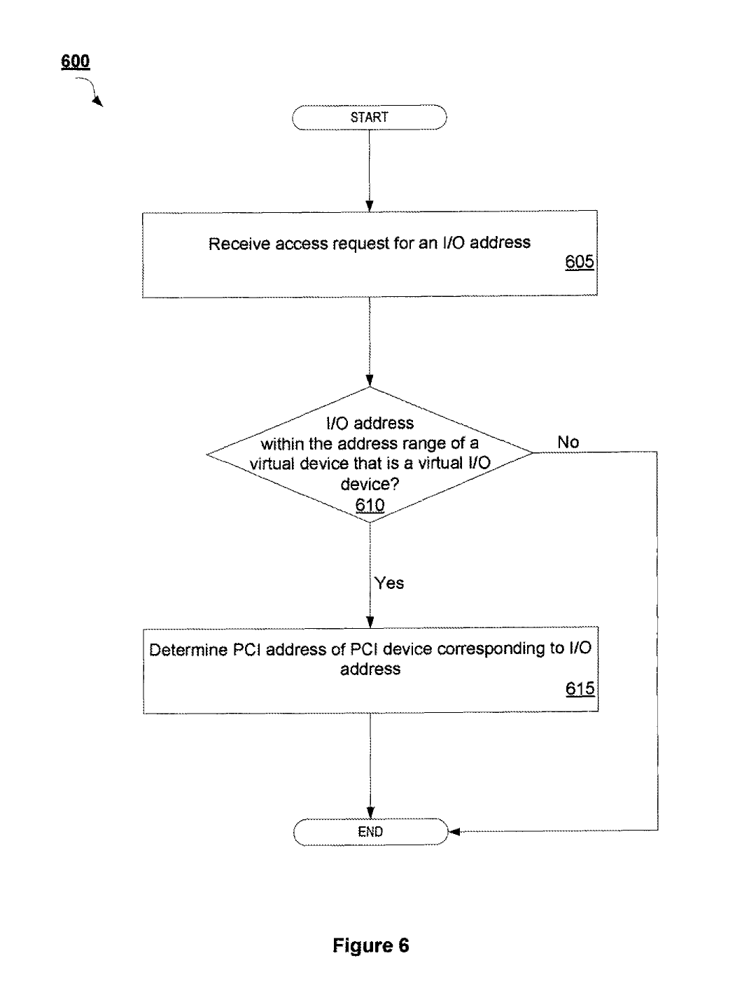

FIG. 6 is a flow diagram of a method 600 for using a virtual device according to an embodiment of the disclosure. Method 600 may be performed by processing logic that may comprise hardware (e.g., circuitry, dedicated logic, programmable logic, microcode, etc.), software (such as instructions run on a processing device), firmware, or a combination thereof. In one embodiment, method 600 is performed by device 100 described with respect to FIG. 1.

At block 605, processing logic receives an access request for an I/O address. In one embodiment, the I/O address is an MMIO address. In one embodiment, the access request for the I/O address is received from software.

At block 610, processing logic determines if the I/O address is within the address range of a virtual device that is a virtual I/O device. Processing logic can determine if the I/O address is within the address range of a virtual device that is a virtual I/O device by comparing the I/O address with the address range for each virtual I/O device in a computing system. If processing logic determines the I/O address is not within an address range of a virtual device that is a virtual I/O device, the method 600 ends. If processing logic determines the I/O address is within an address range of a virtual I/O device, the method 600 proceeds to block 615. In one embodiment, block 610 is optional and is not performed. In this embodiment, the determination of whether the I/O address is within the address range of a virtual device that is a virtual I/O device is performed by an SMI handler.

At block 615, processing logic determines a PCI address of a PCI device corresponding to the I/O address. Processing logic can determine the PCI address of the PCI device corresponding to the I/O address by obtaining a PCI address for the I/O address from an SMI handler. In one embodiment, block 615 is optional if the processing logic does not support a memory space trap. In this embodiment, the processing logic will access the I/O address for the virtual I/O device that was previously determined for the virtual I/O device, which exposes the same I/O address as the I/O address of the PCI device.

For example, if the system supports a trap in a memory space, processing logic triggers a SMI when an access occurs in the monitored address range of the virtual device that is a virtual I/O device. In this example, an SMI handler will be triggered and determine if the I/O address is within the address range of the virtual device, and translate from the I/O address to a PCI address.

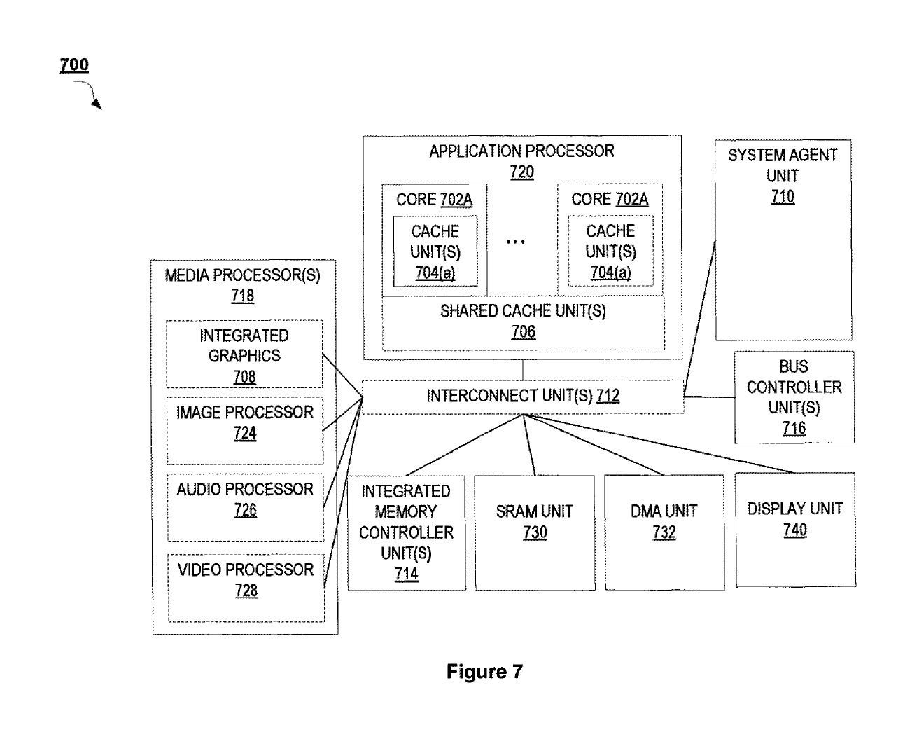

FIG. 7 is a block diagram of a SoC 700 that includes logic circuits to build a virtual PCI device and a virtual MMIO device in accordance with an embodiment of the present disclosure. Dashed lined boxes are optional features on more advanced SoCs. In FIG. 7, an interconnect unit(s) 712 is coupled to: an application processor 720 which includes a set of one or more cores 702A-N and shared cache unit(s) 706; a system agent unit 710; a bus controller unit(s) 716; an integrated memory controller unit(s) 714; a set or one or more media processors 718 which may include integrated graphics logic 708, an image processor 724 for providing still and/or video camera functionality, an audio processor 726 for providing hardware audio acceleration, and a video processor 728 for providing video encode/decode acceleration; an static random access memory (SRAM) unit 730; a direct memory access (DMA) unit 732; and a display unit 740 for coupling to one or more external displays.

The memory hierarchy includes one or more levels of cache within the cores, a set or one or more shared cache units 706, and external memory (not shown) coupled to the set of integrated memory controller units 714. The set of shared cache units 706 may include one or more mid-level caches, such as level 2 (L2), level 3 (L3), level 4 (L4), or other levels of cache, a last level cache (LLC), and/or combinations thereof.

In some embodiments, one or more of the cores 702A-N are capable of multi-threading.

The system agent 710 includes those components coordinating and operating cores 702A-N. The system agent unit 710 may include for example a power control unit (PCU) and a display unit. The PCU may be or include logic and components needed for regulating the power state of the cores 702A-N and the integrated graphics logic 708. The display unit is for driving one or more externally connected displays.

The cores 702A-N may be homogenous or heterogeneous in terms of architecture and/or instruction set. For example, some of the cores 702A-N may be in order while others are out-of-order. As another example, two or more of the cores 702A-N may be capable of execution the same instruction set, while others may be capable of executing only a subset of that instruction set or a different instruction set.

The application processor 720 may be a general-purpose processor, such as a Core™ i3, i5, i7, 2 Duo and Quad, Xeon™, Itanium™, XScale™ or StrongARM™ processor, which are available from Intel Corporation, of Santa Clara, Calif. Alternatively, the application processor 720 may be from another company, such as ARM Holdings, Ltd, MIPS, etc. The application processor 720 may be a special-purpose processor, such as, for example, a network or communication processor, compression engine, graphics processor, co-processor, embedded processor, or the like. The application processor 720 may be implemented on one or more chips. The application processor 720 may be a part of and/or may be implemented on one or more substrates using any of a number of process technologies, such as, for example, BiCMOS, CMOS, or NMOS.

In one embodiment, the application processor 720 also includes logic to implement building a virtual PCI device and a virtual MMIO device according to embodiments of the present invention. For example, the application processor 720 may include logic to execute a virtual device module, such as virtual device module 125 described with respect to FIG. 1, where the virtual device module can build a virtual device based on a request for a peripheral device. The virtual device can be a virtual PCI device or a virtual MMIO device.

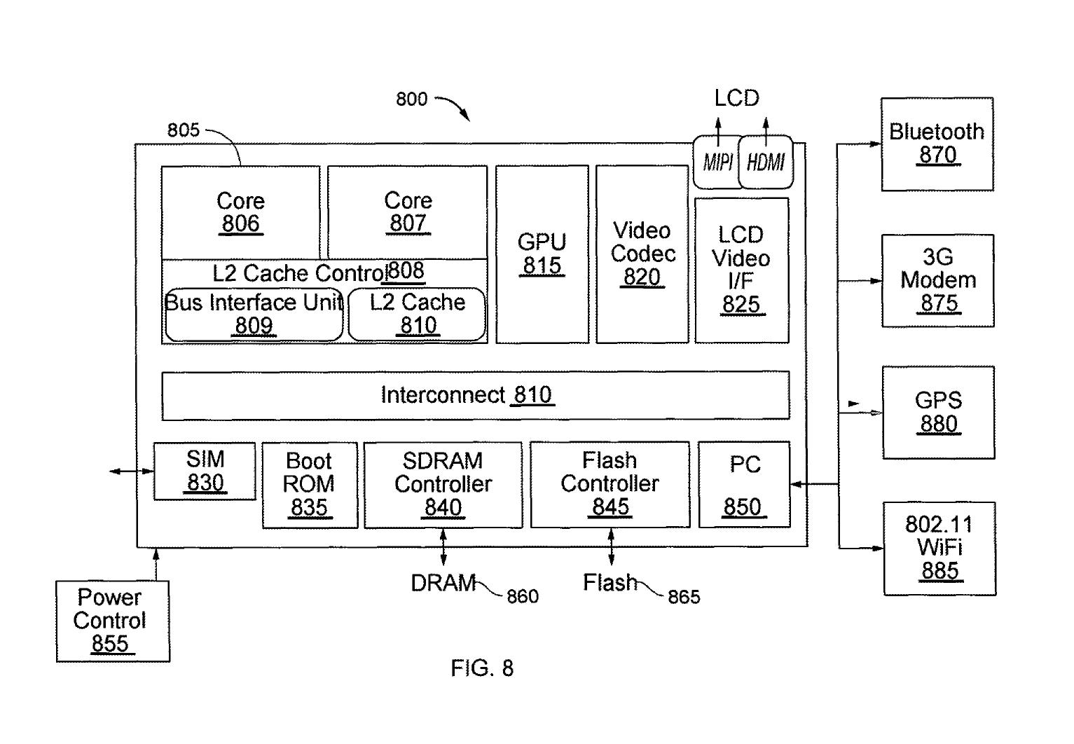

FIG. 8 is a block diagram of an embodiment of a system on-chip (SOC) design in accordance with the present disclosure. As a specific illustrative example, SOC 800 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 800 includes 2 cores—806 and 807. Cores 806 and 807 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 806 and 807 are coupled to cache control 808 that is associated with bus interface unit 809 and L2 cache 810 to communicate with other parts of system 800. Interconnect 810 includes an on-chip interconnect, such as an IOSF, AMBA, or other interconnect discussed above, which potentially implements one or more aspects of the described disclosure.

Interface 810 provides communication channels to the other components, such as a Subscriber Identity Module (SIM) 830 to interface with a SIM card, a boot rom 835 to hold boot code for execution by cores 806 and 807 to initialize and boot SOC 800, a SDRAM controller 840 to interface with external memory (e.g. DRAM 860), a flash controller 845 to interface with non-volatile memory (e.g. Flash 865), a peripheral control 850 (e.g. Serial Peripheral Interface) to interface with peripherals, video codecs 820 and Video interface 825 to display and receive input (e.g. touch enabled input), GPU 815 to perform graphics related computations, etc. Any of these interfaces may incorporate aspects of the disclosure described herein.

In one embodiment, the cores 806 and 807 also include logic to implement building a virtual PCI device and a virtual MMIO device according to embodiments of the present invention. For example, the cores 806 and 807 may include logic to execute a virtual device module, such as virtual device module 125 described with respect to FIG. 1, where the virtual device module can build a virtual device based on a request for a peripheral device, such as DRAM 860, flash 865 etc. The virtual device can be a virtual PCI device or a virtual MMIO device.

In addition, the system 800 illustrates peripherals for communication, such as a Bluetooth module 870, 30 modem 875, GPS 880, and WiFi 885. Note as stated above, a UE includes a radio for communication. As a result, these peripheral communication modules are not all required. However, in a UE, some form a radio for external communication is to be included.

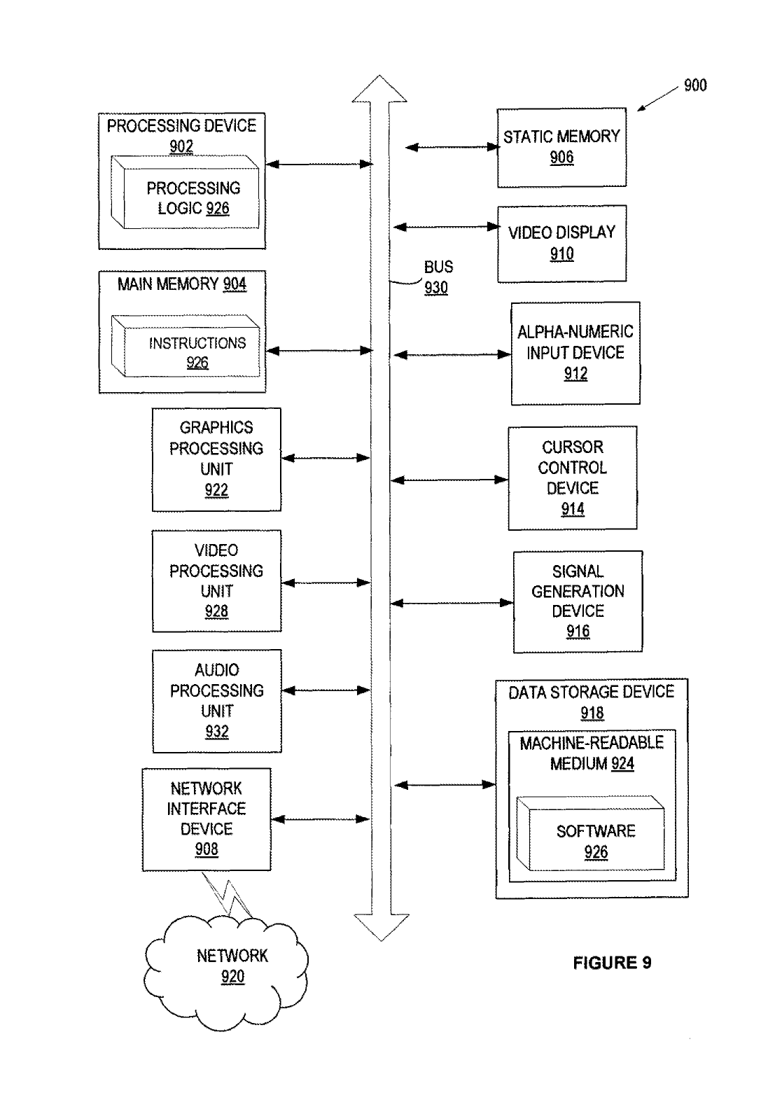

FIG. 9 illustrates a diagrammatic representation of a machine in the example form of a computer system 900 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 900 includes a processing device 902, a main memory 904 (e.g., read-only memory (ROM), flash memory, dynamic random access memory (DRAM) (such as synchronous DRAM (SDRAM) or DRAM (RDRAM), etc.), a static memory 906 (e.g., flash memory, static random access memory (SRAM), etc.), and a data storage device 918, which communicate with each other via a bus 930.

Processing device 902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. In one embodiment, processing device 902 may include one or processing cores. The processing device 902 is configured to execute the processing logic 926 for performing the operations and steps discussed herein. In one embodiment, processing device 902 is the same as processing device 100 described with respect to FIG. 1 that implements a generic method to build a virtual PCI device and a virtual MMIO device. For example, processing device 902 may include a virtual device module, such as virtual device module 125 of FIG. 1.

The computer system 900 may further include a network interface device 908 communicably coupled to a network 920. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 916 (e.g., a speaker). Furthermore, computer system 900 may include a graphics processing unit 922, a video processing unit 928, and an audio processing unit 932.

The data storage device 918 may include a machine-readable storage medium 924 on which is stored software 926 implementing any one or more of the methodologies of functions described herein, such as implementing a generic method to build a virtual PCI device and a virtual MMIO device as described above. The software 926 may also reside, completely or at least partially, within the main memory 904 as instructions 926 and/or within the processing device 902 as processing logic 926 during execution thereof by the computer system 900; the main memory 904 and the processing device 902 also constituting machine-accessible storage media.

The machine-readable storage medium 924 may also be used to store instructions 926 implementing a generic method to build a virtual PCI device and a virtual MMIO device, such as described with respect to device 100 in FIG. 1, and/or a software library containing methods that call the above applications. While the machine-readable storage medium 924 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing, encoding or carrying a set of instruction for execution by the machine and that cause the machine to perform any one or more of the methodologies of the disclosure. The term “machine-readable storage medium” shall accordingly be taken to include, but not be limited to, solid-state memories, and optical and magnetic media.

The following examples pertain to further embodiments.

Example 1 is an apparatus for building a virtual device comprising: 1) a memory; and 2) a processing device communicably coupled to the memory, the processing device to receive a Peripheral Controller Interconnect (PCI) request for a PCI compatible device and build the virtual device based on the PCI compatible device, wherein the virtual device is built as at least one of a virtual PCI device or a virtual Input/Output (I/O) device.

In Example 2, the PCI compatible device of Example 1 can optionally be associated with a software driver, wherein the software driver is to transmit a PCI compatible access request to the virtual device, wherein the virtual device provides the PCI compatible access request to a functional block, and wherein the functional block communicates with the PCI compatible device based on the PCI compatible access request.

In Example 3, an operating system is optionally to be booted from the PCI compatible device using the virtual device of Example 1.

In Example 4, to build the virtual device based on the PCI compatible device, the processing device of Example 1 can optionally build the virtual device as the virtual PCI device upon determining that the PCI compatible device is associated with a functional block that is not PCI compatible; and build the virtual device as the virtual I/O device upon determining that the PCI compatible device is associated with an operating system to be booted from the PCI compatible device.

In Example 5, to build the virtual device as a virtual PCI device, the processing device of Example 4 can optionally determine a vendor identifier for the virtual device, determine device information for the virtual device; and determine address information for the virtual device.

In Example 6, the processing device of Example 5 can optionally send the vendor identifier for the virtual device, the device information for the virtual device, and the address information for the device in response to the request for the PCI compatible device.

In Example 7, to build the virtual device as a virtual I/O device, the processing device of Example 4 can optionally discard the PCI enumeration request for the PCI compatible device; and determine, an I/O address range for the virtual device.

In Example 8, the processing device of Example 1 is optionally receive a memory access for an I/O address; determine whether the I/O address is associated with the virtual device when the virtual device is built as a virtual I/O device; and determine a PCI address associated with the PCI device corresponding to the I/O address upon determining that the I/O address is associated with the virtual device when the virtual device is built as a virtual I/O device.

In Example 9, the virtual I/O device of Example 1 can optionally comprise a virtual Memory-Mapped Input/Output (MMIO) device.

In Example 10, the request of Example 1 can optionally comprise a PCI enumeration request for the PCI compatible device.

Various embodiments may have different combinations of the operational features described above. For instance, all optional features of the apparatus described above may also be implemented with respect to a method or process described herein and specifics in the examples may be used anywhere in one or more embodiments.

Example 11 is a method for building a virtual device comprising 1) receiving a Peripheral Controller Interconnect (PCI) request for a PCI compatible device; and 2) building the virtual device based on the PCI compatible device, wherein the virtual device is built as at least one of a virtual PCI device or a virtual Input/Output (I/O) device.

In Example 12, the PCI compatible device of Example 11 is associated with a software driver, wherein the software driver is to transmit a PCI compatible access request to the virtual device, wherein the virtual device provides the PCI compatible access request to a functional block, and wherein the functional block communicates with the PCI compatible device based on the PCI compatible access request.

In Example 13, an operating system is optionally to be booted from the PCI compatible device using the virtual device of Example 11.

In Example 14, the building the virtual device based on the PCI compatible device of Example 11 can optionally comprise upon determining that the PCI compatible device is associated with a functional block that is not PCI compatible, building the virtual device as the virtual PCI device; and upon determining that the PCI compatible device is associated with an operating system to be booted from the PCI compatible device, building the virtual device as the virtual I/O device.

In Example 15, the building the virtual device as a virtual PCI device of Example 14 can optionally comprise determining a vendor identifier for the virtual device; determining device information for the virtual device; and determining address information for the virtual device.

In Example 16, the subject matter of Example 15 can optionally comprise in response to the request for the PCI compatible device, sending the vendor identifier for the virtual device, the device information for the virtual device, and the address information for the device.

In Example 17, the building the virtual device as a virtual I/O device of Example 14 can optionally comprise discarding the PCI enumeration request for the PCI compatible device; and determining an I/O address range for the virtual device.

In Example 18, the subject matter of Example 11 can optionally comprise receiving a memory access for an I/O address; determining whether the I/O address is associated with the virtual device when the virtual device is built as a virtual I/O device; and upon determining that the I/O address is associated with the virtual device when the virtual device is built as a virtual I/O device, determining a PCI address associated with the PCI device corresponding to the I/O address.

In Example 19, the virtual I/O device of Example 11 can optionally comprise a virtual Memory-Mapped Input/Output (MMIO) device.

In Example 20, the request of Example 11 can optionally comprise a PCI enumeration request for the PCI compatible device.

Various embodiments may have different combinations of the operational features described above. For instance, all optional features of the method described above may also be implemented with respect to a non-transitory, computer-readable storage medium. Specifics in the examples may be used anywhere in one or more embodiments.

Example 21 is a non-transitory, machine-readable storage medium including data that, when accessed by a processing device, cause the processing device to perform the method of Examples 11 to 20.

Example 22 is an apparatus for building a virtual device comprising: 1) a memory; and 2) a computing system coupled to the memory, wherein the computing system is configured to perform the method of any one of the claims 11 to 20.

In Example 23, the computing system of Example 22 can optionally comprise an interface to receive a Peripheral Controller Interconnect (PCI) request for a PCI compatible device; and a virtual device processing block coupled to the interface.

Example 24 is a computing system for building a virtual device comprising: an interface to receive a Peripheral Controller Interconnect (PCI) request for a PCI compatible device; and a virtual device processing block coupled to the interface, wherein the virtual device processing block is to build the virtual device based on the PCI compatible device, wherein the virtual device is built as at least one of a virtual PCI device or a virtual Input/Output (I/O) device.

In Example 25, the virtual device processing block of Example 24 can optionally comprise: a virtual device determination block to determine whether the PCI compatible device is associated with a functional block that is not PCI compatible and to determine whether the PCI compatible device is associated with an operating system to be booted from the PCI compatible device; a virtual PCI device creation block to build the virtual device as the virtual PCI device when the PCI compatible device is associated with a functional block that is not PCI compatible; and a virtual I/O device creation block to build the virtual device as the virtual I/O device when the PCI compatible device is associated with an operating system to be booted from the PCI compatible device.

In Example 26, to build the virtual device as a virtual PCI device, the virtual PCI device creation block of Example 25 is optionally to determine a vendor identifier for the virtual device; determine device information for the virtual device; and determine address information for the virtual device.

In Example 27, to build the virtual device as a virtual I/O device, the virtual I/O device creation block of Example 25 is optionally to discard the PCI enumeration request for the PCI compatible device; and determine an I/O address range for the virtual device.

In Example 28, the virtual device processing block of Example 24 can optionally send the vendor identifier for the virtual device, the device information for the virtual device, and the address information for the device in response to the request for the PCI compatible device.

In Example 29, the virtual device processing block of Example 24 can optionally comprise a virtual I/O device address translation block to receive a memory access for an I/O address, to determine whether the I/O address is associated with the virtual device when the virtual device is built as a virtual I/O device, and upon determining that the I/O address is associated with the virtual device when the virtual device is built as a virtual I/O device, to determine a PCI address associated with the PCI device corresponding to the I/O address.

Example 30 is a non-transitory machine-readable storage medium including instructions that, when executed by a computing system, cause the computing system to perform operations comprising: 1) receiving a Peripheral Controller Interconnect (PCI) request for a PCI compatible device; and 2) building the virtual device based on the PCI compatible device, wherein the virtual device is built as at least one of a virtual PCI device or a virtual Input/Output (I/O) device.

In Example 31, wherein the PCI compatible device of Example 30 can optionally be associated with an software driver, wherein the software driver can optionally transmit a PCI compatible access request to the virtual device, wherein the virtual device of Example 30 can optionally provide the PCI compatible access request to a functional block, and wherein the functional block can optionally communicate with the PCI compatible device based on the PCI compatible access request.

In Example 32, an operating system is to be booted from the PCI compatible device using the virtual device of Example 30.

In Example 33, wherein building the virtual device based on the PCI compatible device of Example 30 can optionally comprise: upon determining that the PCI compatible device is associated with a functional block that is not PCI compatible, building the virtual device as the virtual PCI device; and upon determining that the PCI compatible device is associated with an operating system to be booted from the PCI compatible device, building the virtual device as the virtual I/O device.

In Example 34, building the virtual device as a virtual PCI device of Example 33 can optionally comprise determining a vendor identifier for the virtual device; determining device information for the virtual device; and determining address information for the virtual device.

In Example 35, building the virtual device as a virtual PCI device of Example 34 can optionally comprise sending the vendor identifier for the virtual device, the device information for the virtual device, and the address information for the device in response to the request for the PCI compatible device.

In Example 36, building the virtual device as a virtual I/O device of Example 33 can optionally comprise discarding the PCI enumeration request for the PCI compatible device; and determining an I/O address range for the virtual device.

In Example 37, the subject matter of Example 30 can optionally comprise: receiving a memory access for an I/O address; determining whether the I/O address is associated with the virtual device when the virtual device is built as a virtual I/O device; and upon determining that the I/O address is associated with the virtual device when the virtual device is built as a virtual I/O device, determining a PCI address associated with the PCI device corresponding to the I/O address.

Example 38 is apparatus for building a virtual device comprising: 1) an interface to receive a Peripheral Controller Interconnect (PCD request for a PCI compatible device; and 2) means for building the virtual device based on the PCI compatible device, wherein the virtual device is built as at least one of a virtual PCI device or a virtual Input/Output (I/O) device.

In Example 39, the means for building the virtual device based on the PCI compatible device of Example 38 can optionally comprise: means for determining whether the PCI compatible device is associated with a functional block that is not PCI compatible; means for building the virtual device as the virtual PCI device upon determining that the PCI compatible device is associated with a functional block that is not PCI compatible; means for determining whether the PCI compatible device is associated with an operating system to be booted from the PCI compatible device; and means for building the virtual device as the virtual I/O device upon determining that the PCI compatible device is associated with an operating system to be booted from the PCI compatible device.

In the foregoing description, numerous details are set forth. It will be apparent, however, to one skilled in the art, that the disclosure may be practiced without these specific details. In some instances, well-known structures and devices are shown in block diagram form, rather than in detail, in order to avoid obscuring the disclosure.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “sending”, “receiving”, “generating”, “determining”, “creating”, “translating”, “discarding”, “comparing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may comprise a general purpose computer selectively activated or reconfigured by a computer program stored in the computer. Such a computer program may be stored in a machine-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct a more specialized apparatus to perform the operations. The required structure for a variety of these systems will appear from the description below. In addition, the present embodiments are not described with reference to any particular programming language. It will be appreciated that a variety of programming languages may be used to implement the teachings of the embodiments as described herein.

The disclosure may be provided as a computer program product, or software, that may include a machine-readable medium having stored thereon instructions, which may be used to program a computer system (or other electronic devices) to perform a process according to the disclosure. A machine-readable medium includes any technology for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

Whereas many alterations and modifications of the disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the disclosure.

1-22. (canceled)

23. An apparatus for building a virtual device, comprising:
a memory; and
a processing device communicably coupled to the memory, the processing device to:
receive a Peripheral Controller Interconnect (PCI) request for a PCI compatible device;
build the virtual device based on the PCI compatible device, wherein the virtual device is built as at least one of a virtual PCI device or a virtual Input/Output (I/O) device.

24. The apparatus of claim 23, wherein the PCI compatible device is associated with a software driver, wherein the software driver is to transmit a PCI compatible access request to the virtual device, wherein the virtual device provides the PCI compatible access request to a functional block, and wherein the functional block communicates with the PCI compatible device based on the PCI compatible access request.

25. The apparatus of claim 23, wherein an operating system is to be booted from the PCI compatible device using the virtual device.

26. The apparatus of claim 23, wherein to build the virtual device based on the PCI compatible device, the processing device is to:
upon determining that the PCI compatible device is associated with a functional block that is not PCI compatible, build the virtual device as the virtual PCI device; and
upon determining that the PCI compatible device is associated with an operating system to be booted from the PCI compatible device, build the virtual device as the virtual I/O device.

27. The apparatus of claim 26, wherein to build the virtual device as a virtual PCI device comprises:
determining a vendor identifier for the virtual device;
determining device information for the virtual device; and
determining address information for the virtual device.

28. The apparatus of claim 27, wherein the processing device is further to:
in response to the request for the PCI compatible device, send the vendor identifier for the virtual device, the device information for the virtual device, and the address information for the device.

29. The apparatus of claim 26, wherein to build the virtual device as a virtual I/O device comprises:
discarding the PCI enumeration request for the PCI compatible device; and
determining an I/O address range for the virtual device.

30. The apparatus of claim 23, wherein the processing device is further to:
receive a memory access for an I/O address;
determine whether the I/O address is associated with the virtual device when the virtual device is built as a virtual I/O device; and
upon determining that the I/O address is associated with the virtual device when the virtual device is built as a virtual I/O device, determine a PCI address associated with the PCI device corresponding to the I/O address.

31. The apparatus of claim 23, wherein the virtual I/O device is a virtual Memory-Mapped Input/Output (MMIO) device.

32. A method for building a virtual device, the method comprising:
receiving, by a processing device, a Peripheral Controller Interconnect (PCI) request for a PCI compatible device; and
building, by the processing device, the virtual device based on the PCI compatible device, wherein the virtual device is built as at least one of a virtual PCI device or a virtual Input/Output (I/O) device.

33. The method of claim 32, wherein the PCI compatible device is associated with a software driver, wherein the software driver is to transmit a PCI compatible access request to the virtual device, wherein the virtual device provides the PCI compatible access request to a functional block, and wherein the functional block communicates with the PCI compatible device based on the PCI compatible access request.

34. The method of claim 32, wherein an operating system is to be booted from the PCI compatible device using the virtual device.

35. The method of claim 32, wherein building the virtual device based on the PCI compatible device comprises:
upon determining that the PCI compatible device is associated with a functional block that is not PCI compatible, building the virtual device as the virtual PCI device; and
upon determining that the PCI compatible device is associated with an operating system to be booted from the PCI compatible device, building the virtual device as the virtual I/O device.

36. The method of claim 33, wherein building the virtual device as a virtual PCI device comprises:
determining a vendor identifier for the virtual device;
determining device information for the virtual device; and
determining address information for the virtual device.

37. The method of claim 36, further comprising:
in response to the request for the PCI compatible device, sending the vendor identifier for the virtual device, the device information for the virtual device, and the address information for the device.

38. The method of claim 35, wherein building the virtual device as a virtual I/O device comprises:
discarding the PCI enumeration request for the PCI compatible device; and
determining an I/O address range for the virtual device.

39. The method of claim 32, further comprising:
receiving a memory access for an I/O address;
determining whether the I/O address is associated with the virtual device when the virtual device is built as a virtual I/O device; and
upon determining that the I/O address is associated with the virtual device when the virtual device is built as a virtual I/O device, determining a PCI address associated with the PCI device corresponding to the I/O address.

40. The method of claim 32, wherein the request is a PCI enumeration request for the PCI compatible device.

41. A non-transitory machine-readable storage medium including instructions that, when executed by a computing system, cause the computing system to perform operations comprising:
receiving a Peripheral Controller Interconnect (PCI) request for a PCI compatible device; and
building the virtual device based on the PCI compatible device, wherein the virtual device is built as at least one of a virtual PCI device or a virtual Input/Output (I/O) device.

42. The non-transitory machine-readable storage medium of claim 41, wherein the PCI compatible device is associated with an software driver, wherein the software driver is to transmit a PCI compatible access request to the virtual device, wherein the virtual device provides the PCI compatible access request to a functional block, and wherein the functional block communicates with the PCI compatible device based on the PCI compatible access request.

43. The non-transitory machine-readable storage medium of claim 41, wherein an operating system is to be booted from the PCI compatible device using the virtual device.

44. The non-transitory machine-readable storage medium of claim 41, wherein building the virtual device based on the PCI compatible device comprises:
upon determining that the PCI compatible device is associated with a functional block that is not PCI compatible, building the virtual device as the virtual PCI device; and
upon determining that the PCI compatible device is associated with an operating system to be booted from the PCI compatible device, building the virtual device as the virtual I/O device.

45. The non-transitory machine-readable storage medium of claim 44, wherein building the virtual device as a virtual PCI device comprises:
determining a vendor identifier for the virtual device;
determining device information for the virtual device; and
determining address information for the virtual device.

46. The non-transitory machine-readable storage medium of claim 44, wherein building the virtual device as a virtual I/O device comprises:
discarding the PCI enumeration request for the PCI compatible device; and
determining an I/O address range for the virtual device.

47. The non-transitory machine-readable storage medium of claim 41, wherein the operations further comprise:
receiving a memory access for an I/O address;
determining whether the I/O address is associated with the virtual device when the virtual device is built as a virtual I/O device; and
upon determining that the I/O address is associated with the virtual device when the virtual device is built as a virtual I/O device, determining a PCI address associated with the PCI device corresponding to the I/O address.
